(19) United States
(12) Patent Application Publication
(10) Pub. No.: US 2011/0255317 A1
(43) Pub. Date: Oct. 20, 2011

(54) INTELLIGENT MULTI-STAGE VARIABLE-POWER SWITCH POWER SUPPLY DEVICE

(76) Inventor: Xia Zhubing, Shenzhen City (CN)

(21) Appl. No.: 13/086,304

(22) Filed: Apr. 13, 2011

(30) Foreign Application Priority Data
Apr. 14, 2010 (CN) 201010147604.0

(51) Int. Cl. H02M 7/04

(52) U.S. Cl. 363/125

(57) ABSTRACT

An intelligent multi-stage variable-power switch power supply device has an output of a bridge rectifier connected with the input of an EMI filter and the output of the EMI filter connected with a single chip through a standby topology and is connected with two or more different power topologies through different MOSFET switches respectively. The standby topology is connected with a load through a standby current sensor and a load detection circuit in turn and with the different power topologies being connected with loads through respective corresponding working current sensors. The output of standby current sensor, the outputs of the working current sensors and the output of the load detection circuit are connected with the input of the single chip respectively, while the output of the single chip is connected with the inputs of a plurality of MOSFET switches to control the on and off states of the different power topologies. The intelligent multistage variable-power switch power supply device of the invention can automatically select a proper power topology according to the load change, reduce the influences of load change on power supply efficiency and improve power supply efficiency.

### BACKGROUND OF THE INVENTION

1. Technical Field of the Invention

The present invention relates to a switch power supply device, in particular to an intelligent multi-stage variable-power switch power supply device.

2. Description of the Prior Art

With the pursuit of energy conservation and emission reduction in society, people are seeking a low-carbon lifestyle, and the era of extensive electricity consumption is nearing an end, in favor of greater electricity conservation. In the past, people neither paid close attention to the power of household appliances nor cared much about the efficiency of lighting circuits; however, in the age of LED illumination, the low power consumption and high efficiency of LEDs have become popular and are widely applied.

Since low-voltage direct current is the optimum environment for the LEDs, the voltage of a single LED is 3.0V DC-5V DC, however, the current social power supply is 220V AC, so that each lamp holder requires a conversion of 220V AC into the low-volt-age direct current (12V DC or 24V DC.) Nevertheless, many high-quality power devices have high power efficiency but are expensive, which is problematic to business users and household users. Consequently, many manufacturers adopt linear adjustment topologies for lowering voltage by connecting resistors in series, characterized by low-cost and low-efficiency (less than 50%), which neutralizes LED's advantage of energy conservation; such products even consume more power than fluorescent lamps. If multiple low-voltage DC low-power devices share the same high-efficient power supply, there will be a very big load change. For example, the load may reach a designed full load, 300 W, when a user turns on all lamps, while the load is only about 10 W when only a lamp in a study room is turned on in the daytime. According to the technical characteristics of switch power supply, the 300 W switch power supply may have an efficiency of about 85% when the power is in the range of 60 W to 300 W (20% to 100% of the rated power), while the efficiency is quickly reduced to less than 80% (as shown in FIG. 1) when the load is less than 60 W (20% of the rated power).

### SUMMARY OF THE INVENTION

The present invention is directed toward addressing and achieving the following objects: As for the technical problem of reduced power efficiency due to load variation in the prior art, an intelligent multi-stage variable-power switch power supply device is provided, which can automatically select a proper power topology according to the load change, reduce the influences of load change on power supply efficiency and improve the power supply efficiency.

The present invention is realized by the technical scheme as follows: An intelligent multi-stage variable-power switch power supply device is provided; in the device, the output of a bridge rectifier is connected with the input of an EMI filter; the output of the EMI filter is connected with a single chip through a standby topology and is connected with two or more different power topologies through different MOSFET switches respectively; the standby topology is connected with a load through a standby current sensor and a load detection circuit in turn; the different power topologies are connected with loads through respective corresponding working current sensors; the output of standby current sensor, the outputs of the working current sensors and the output of the load detection circuit are connected with the input of the single chip respectively; and the output of the single chip is connected with the inputs of a plurality of MOSFET switches to control the “on” and “off” states of the different power topologies. When the single chip detects the user's loads through the load detection circuit, the MOSFET switches in connection with power topologies having the maximum power are electrified; the power topologies are matched from the maximum power to the minimum power one by one based on the size of load current; and. finally, the matched power topology is fixed to realize a stable operation state. Thus, the load is automatically detected by the single chip and the power topology most appropriate to the size of the load is selected by controlling the MOSFET switches connected with respective power topologies so as to realize the highest power efficiency of variable loads in a user environment. Respective power topology has a current limit function to limit the current lower than an upper limit, thereby preventing damage on devices in the power topologies. The single chip works in a standby topology so as to realize an intelligent management.

In the intelligent multi-stage variable-power switch power supply device, the output of the single chip is further connected with an LED status lamp and a fan, and the output of the temperature sensor is connected with the input of the single chip.

In the intelligent multi-stage variable-power switch power supply device, the load is connected with the input of the single chip through a ripple detection circuit.

The intelligent multistage variable-power switch power supply device has the following advantageous technical effects: The invention provides two or more different power topologies; the actual current of a current load is detected through the single chip, and the most proper power topology is correspondingly computed and selected through the single chip, so that the intelligent multi-stage variable-power switch power supply device can adapt to the load change, thereby avoiding reduced power efficiency in case of a low load rate. At the same time, loads in connection with the intelligent multi-stage variable-power switch power supply device can obtain very accurate low-voltage DC power that has small ripples and is far less than the fluctuation of 220V AC, and thus the service life of the loads is prolonged greatly. For example, lamps have the service life far less than a theoretical value due to high voltage (regularly 240V AC) of the grid at the time after midnight, and the actual service life is less than two years on average, however, accurate DC power can be obtained by using the intelligent multi-stage variable-power switch power supply device and therefore, the service life is prolonged greatly. The device can be used in DC-DC applications or AC-DC applications; moreover, a plurality of power topologies may share a set of front-end AC rectifiers and EMI circuits, without increasing the cost. The popularization of low cost is available by using low-voltage DC LEDs; a plurality of LED low-voltage DC lamps share one switch power supply device of the invention to supply power to a plurality of LED low-voltage DC lamps in a range at a short distance (less than 50 m, e.g., a part for household or business use) or to house-hold appliances with low power consumption, such as low-voltage DC chargers, desk lamps, soya-bean milk makers, household routers and the like.

Other objects and features of the present invention will become apparent when considered in combination with the accompanying drawing figures which illustrate certain preferred embodiments of the present invention. It should, however, be noted that the accompanying drawing figures are intended to illustrate only certain embodiments of the claimed invention and are not intended as a means for defining the limits and scope of the present invention.

### BRIEF DESCRIPTION OF THE DRAWING FIGURES

In the drawing, wherein similar reference numerals and symbols denote similar features throughout the several views:

FIG. 1 is a power efficiency curve chart of the percentage of load to rated power in the prior art;

FIG. 2 is a power efficiency curve chart in case of three rated output powers (20 W/80 W/300 W) of the present invention; and,

FIG. 3 is a structure diagram of the intelligent multi-stage variable-power switch power supply device of the present invention.

### DETAILED DESCRIPTION OF THE PREFERRED EMBODIMENTS AND DRAWING FIGURES

Turning now, in detail, to an analysis of the accompanying drawing figures, as shown in FIG. 3, in the intelligent multi-stage variable-power switch power supply device of the preferred embodiment, the output of a bridge rectifier 1 is connected with the input of an EMI filter 2; the output of the EMI filter 2 is connected with a single chip 4 through a standby topology 3; the output of the EMI filter 2 is connected with a 20 W power topology 15 through a first MOSFET switch 12, a 80 W power topology 16 through a second MOSFET switch 13, and a 300 W power topology 17 through a third MOSFET switch 14. The standby topology 3 is connected with a load 5 through a standby current sensor 7 and a load detection circuit 6 in turn; the 20 W power topology 15, the 80 W power topology 16 and the 300 W power topology 17 are connected with a load 5 through the first current sensor 18, the second current sensor 19 and the third current sensor 20; and the output of the standby current sensor 7, the outputs of the working current sensors and the output of the load detection circuit 6 are connected with the input of the single chip 4, respectively; and the output of the single chip 4 is connected with the inputs of a plurality of MOSFET switches. The output of the single chip 4 is further connected with an LED status lamp 8 and a fan 9, and the output of a temperature sensor 10 is connected with the input of the single chip 4. The load 5 is connected with the input of the single chip 4 through the ripple detection circuit 11. The single chip 4 obtains working power from the standby topology 3 and detects the current of the load to determine which power topology shall be selected; the power topology is switched on and other power topologies are switched off through the MOSFET switches; the single chip 4 receives data from the temperature sensor 10, judges whether to supply power to the fan 9 and determines the revolution speed of the fan 9 in combination with the current power topology; and, moreover, the single chip 4 can also determine the heating condition of a power supply line through the detection of current and provide an alarm and treatment. The single chip 4 will monitor the current power working status, control the LED status lamp 8 and report the current working status to a user. For example, a green light indicates a good condition, i.e., within the current range and voltage range pre-designed by the current power topology; additionally, the single chip 4 enters a preset logic; a plurality of LED status lamps 8 can also be used to indicate the current power topology; and when a power topology is in operation, the corresponding LED status lamp 8 will go on. The single chip 4 monitors the output voltage ripple of the current topology, reports rational and irrational ripples and enters the preset logic; and, further, the single chip 4 monitors the working temperature of the current power, displays the temperature on an indicator lamp and enters the preset logic.

After the bridge rectifier 1 of the intelligent multistage variable-power switch power supply device of the preferred embodiment is powered on, the standby topology 3 starts to work and supplies small current to the single chip 4; the preferred embodiment outputs 36V DC; the power topologies are a 20 W power topology 15, an 80 W power topology 16 and a 300 W power topology 17, respectively. Based on the design, the current is 0.014 A to 0.020 A (only 0.5 W) in a standby state; the current is 0.556 A at a critical state when the load 5 is 20 W; the current is 2.222 A at a critical state when the load 5 is 80 W; and the current is 8.333 A at a critical state when the load 5 is 300 W.

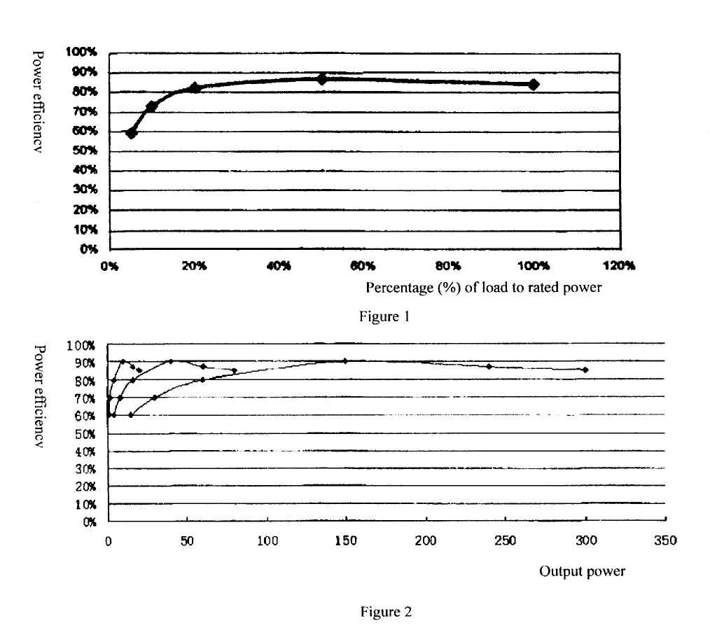

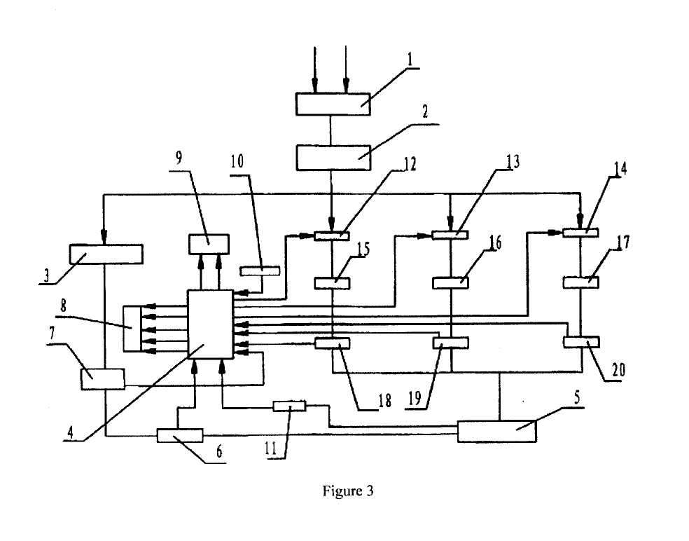

At the very initial several minutes, the single chip 4 automatically connects the load 5 to the 300 W power topology 17 and detects whether the current of the load 5 is between 2.222 A and 8.333 A; if it is so, the power topology requires no replacement, and a report is required for the LED status lamp 8. When the current drops to less than 2.178 A (2.222 A*98%), the single chip 4 connects the load 5 to the 80 W power topology 16. When the current drops to less than 0.545 A (0.556 A*98%), the single chip 4 connects the load 5 to the 20 W power topology 15. When the current drops to less than 0.018 A (0.020 A*90%), the single chip 4 controls the load 5 to be in a standby status and turns off all the MOSFET switches. In turn, when the single chip 4 monitors the load 5 works on the standby topology 3 and detects the current exceeding 0.018 A, the load 5 will be connected to the power topology with the highest power, followed by repeating the process of selecting power topologies from the bigger one to the smaller one. When the single chip 4 monitors the load 5 works on the 20 W power topology 15 and detects the current exceeding 0.545 A, the load 5 will be connected to the 300 W power topology 17, followed by repeating the process of selecting power topologies from the bigger one to the smaller one. The load is connected to the highest power topology at each upward jump, and the power topology with the highest efficiency is selected from the bigger one to the smaller one step by step. When the current power topology jumps to a target power topology, the single chip 4, firstly powers on the MOSFET switch of the target power topology and connects the load 5 to the target power topology, followed by powering off the MOSFET switch of the current power topology. When the single chip 4 detects a high jump frequency and continuous up-and-down reciprocation, there is a system failure, instead of rational change of use's loads, and the single chip 4 will turn off all power topologies and provides an alarm for the LED status lamp 8. As the power of the load 5 varies, the power can work on a smooth curve at an efficiency of more than 80% (as shown in the top of three curves in FIG. 2.)

The intelligent multi-stage variable-power switch power supply device of the present invention can provide perfect power supply for household LED lighting and business LED lighting within a range of less than 100 square meters. Moreover, the device can be used for driving a plurality of small LED lighting areas, thereby providing perfect power supply for business LED lighting within a range of more than 100 square meters. In spite of the great power variation of the load 5 (variation of current size), the power efficiency can not reduced greatly; in addition, the power topology with the highest efficiency is selected in comparison with the current load condition.

In alternative embodiments of the present invention, there may be two or more power topologies based on specific conditions and actual needs, and all the power topologies can achieve the purposes of the invention.

### LIST OF REFERENCE NUMERALS

1 bridge rectifier
2 EMI filter
3 standby topology
4 single chip
5 load
6 load detection circuit
7 standby current sensor
8 LED status lamp
9 fan
10 temperature sensor
11 ripple detection circuit
12 first MOSFET switch
13 second MOSFET switch
14 third MOSFET switch
15 20 W power topology
16 80 W power topology
17 300 W power topology
18 first current sensor
19 second current
20 third current sensor

What is claimed is:

1. An intelligent multi-stage variable-power switch power supply device, comprising: an output of a bridge rectifier being connected with an input of an EMI filter, the output of said EMI filter being connected with a single chip through a standby topology and connected with a plurality of different power topologies through different MOSFET switches respectively, a standby topology being connected with a load through a standby current sensor and a load detection circuit and, in turn, a plurality of said stand-by topologies are connected with the load through respective corresponding working current sensors, the output of said standby current sensor, outputs of the working current sensors and an output of said load detection circuit are connected with an input of said single chip, respectively, and with an output of said single chip being connected with inputs of a plurality of MOSFET switches.

2. The intelligent multi-stage variable-power switch power supply device according to claim 1, wherein the output of said single chip is further connected to an LED status lamp and a fan, and further comprising a temperature sensor with an output of said temperature sensor is connected with the input of said single chip.

3. The intelligent multi-stage variable-power switch power supply device according to claim 1, further comprising a ripple detection circuit with the load being connected with the input of said single chip through said ripple detection circuit.
